(19) United States
(12) Patent Application Publication
(10) Pub. No.: US 2005/0097820 A1
(43) Pub. Date: May 12, 2005

(54) Fuel reformer for hydrogen production, especially for operation of a fuel cell

(76) Inventors: Ian Faye, Stuttgart (DE); Rainer Saliger, Bamberg (DE); Thanh-Binh Truong, Buchs (CH); Esmond Newson, Schaffhausen (CH)

Correspondence Address: STRIKER, STRIKER & STENBY, 103 EAST NECK ROAD, HUNTINGTON, NY, 11743, US

(21) Appl. No.: 10/939,247

(22) Filed: Sep. 10, 2004

(30) Foreign Application Priority Data
Nov. 12, 2003 (DE) 103 52 798.2

(51) Int. Cl. H01M 8/04

(52) U.S. Cl. 48/214 A; 48/127.9; 48/214 R; 48/215

(57) ABSTRACT

The fuel reformer, especially for a fuel cell, produces a hydrogen-containing reformate from a fuel or hydrocarbon mixture supplied to it by partial oxidation (POX) and/or an autothermal reforming process. The reformer provides improved local reaction temperatures with increased conversion of hydrocarbons to hydrogen, decreased residual carbon monoxide formation and at the same time an increased yield of hydrogen. A gas supply member for distribution of reactants, such as air and/or oxygen, is arranged within the flow path of the fuel or hydrocarbon mixture in the reformer. The gas supply member has a plurality of gas supply outlets distributed in a flow direction along the fuel flow path for supplying the reactants to a catalyst material, which are distributed and formed so that reaction regions are more uniformly distributed along the flow path.

### BACKGROUND OF THE INVENTION

1. Field of the Invention

The present invention relates to a fuel reformer, especially for operation of a fuel cell, for production of a hydrogen-containing reformate from a fuel or hydrocarbon mixture supplied to the reformer, on the basis of a partial oxidation (POX) and/or autothermal reforming process, with a catalyst for at least one catalytic reaction.

2. Description of Related Art

Fuel cell technologies based on hydrogen for mobile and stationary applications have been currently developed. Low-temperature polymer electrolyte membrane (PEM) fuel cells and the high-temperature (Solid oxide) fuel cells are two possible technologies, which have reached the prototype stage.

The hydrogen required for operation of fuel cells is produced by reforming the reactants, water and air or if necessary also pure oxygen and fuel, such as liquid and/or gaseous hydrocarbons, by means of a fuel reformer, especially a catalytic reactor. So-called hot spots, in which exothermic reactions occur, and so-called cold spots, in which endothermic reactions occur, are present according to which reformate process is used.

The operating temperature of a catalytic reactor is generally over 1200° C. because of the vigorous exothermic reaction occurring. In this case a “total oxidation”(TOX) of the fuel (e.g. isooctane C₈H₁₈) to carbon dioxide and water occurs, in so far as sufficient oxygen is present. For example, the following reaction takes place and is given by equation I:
C₈H₁₈+12.5 O₂→8 CO₂+9H₂O (I).
Different processes are used for production of hydrogen from fuel.

1.) When the oxygen supplied is reduced in comparison to TOX, a “partial oxidation” (POX) occurs. Hydrocarbon and air or oxygen also react with each other in that case. However only a partial oxidation of the fuel takes place according to e.g. the following reaction given by equation II:
C₈H₁₈+6 O₂→4 CO₂+4 CO+9 H₂ (II).

This reforming process is exothermic and produces temperatures of about 900 to 1100° C. The CO content is very high at about 10 to 20%. The reactions in the reformer can be influenced by several parameters in this process. The amounts and pressure ratios of the reactants and the catalysts are selected accordingly.

2.) “Steam reforming” (STR, Steam reforming) is an additional reforming process. Hydrocarbons and water and/or steam are reacted with each other at temperatures between 600° C. and 900° C. An external burner produces these temperatures in the reformer. Because of that a comparatively uniform temperature distribution exists in the reformer. For example, the following reaction occurs and is given by equation III:
C₈H₁₈+14H₂O→6 C₂+2 CO+23 H₂ (I).

The steam reforming process is an endothermic process and in contrast to partial oxidation requires energy for reforming. This energy must be supplied from the outside by e.g. a heat exchanger. The CO content in this reforming process is at about 1 to 5%. The hydrogen yield is considerably higher in contrast to partial oxidation, since hydrogen is removed from the supplied steam.

A combination of both reforming processes is called “autothermic reforming”. In this type of process the reactor includes both the partial oxidation and the steam reforming process.

The exothermic reaction, the partial oxidation, has a very high reaction rate and thus occurs very rapidly, above all at the entrance of this sort of reactor. The temperatures in this “hot spot” can amount to 900° C. Because of the limited heat transfer and reduced reaction rate the heat required for steam reforming occurs in a downstream region and the steam reforming produces a so-called “cold spot”. Additional heat can be supplied from the outside to avoid formation of a cold spot, which is too cold. The term “autothermic reforming process” is understood in the following to be the entire area between a purely “steam reforming” process and a “partial oxidation” process.

The temperatures existing at the outlet of the reactor when the reactor is operated in this autothermic area are about 500 to 700° C. These temperatures are temperatures of the reformate issuing from the reformer. The lower temperature value occurs in the case that no additional heat is supplied from the outside. The CO content of the autothermic reforming amounts to about 5 to 10%.

The fraction of carbon monoxide CO remaining however is harmful or noxious in the case of all reforming processes used for low temperature fuel cells. Thus gas purification stages must be subsequently connected for the reformate gas in order to be able to keep the CO content to an acceptable level, for example 50 ppm CO, which require, i.a., a multi-stage purification process. The higher the CO output concentration, the higher the purification expenses.

### SUMMARY OF THE INVENTION

It is an object of the present invention to provide a fuel reformer of the above-described kind, in which the local reaction temperatures in the reformer are improved during the reforming of hydrogen by a partial oxidation and/or an autothermal reforming process, which increases the conversion of hydrocarbons, lowers the fraction of carbon monoxide remaining and at the same time increases the yield of hydrogen.

It is also an object of the present invention to provide a method of operating the fuel reformer according to the invention to produce a hydrogen-containing reformate with a higher yield of hydrogen and a lower fraction of carbon monoxide.

This object and others, which will be made more apparent hereinafter, are attained in a fuel reformer, especially for operation of a fuel cell, for production of a hydrogen-containing reformate from a fuel or hydrocarbon mixture supplied to the reformer, on the basis of a partial oxidation (POX) and/or autothermal reforming process, with a catalyst for at least one catalytic reaction.

According to the invention the fuel reformer comprises a gas supply member for supply of reactants, such as air and/or oxygen, and the gas supply member is provided with a plurality of outlets distributed along a flow path of the fuel or the hydrocarbon mixture and/or the reformate product in the reformer.

Preferred embodiments of the reformer are described and claimed in the appended dependent claims.

Because of the reformer structure according to the present invention several reaction regions are formed distributed along the flow path of the fuel and/or the reformate, in which locally smaller energy amounts are released in appropriate reaction regions by the operating reforming process. Because of that a more uniform distribution of the individual reactions and thus the reaction temperatures connected with them occurs over the entire flow path, so that a more controlled reforming process is possible.

The inventive concept is that an increase of the fuel conversion and the hydrogen fraction and a reduction of the carbon monoxide fraction are achieved in contrast to the complete oxidation to be expected by the addition of additional oxygen along the flow path. Among other things, this is possible due to the reduced temperatures in the so-called “hot spots” in contrast to the known process.

By reduction of the temperatures differences and also the lower temperature peaks a very positive course of the reaction results along the flow path of the fuel and/or of the reformate, so that a definitely higher yield of hydrogen and reduction in the residual carbon monoxide are attained in contrast to the currently known processes. Also lower reforming temperatures as well as a reduction of the HC throughput are attained.

According to the structure of the fuel cell unit savings can be made even in the case of the gas purification stage in operation of the fuel cell unit.

In a first embodiment of the fuel reformer according to the invention multiple outlets for the supplying reactants can be arranged to supply the reactants in a direction transverse or across the flow path of the fuel and/or the reformate. Because of that a more uniform distribution of the air and/or oxygen supplied along the flow path of the reformer is achieved.

In an accordingly improved embodiment the open cross-section of the gas supply members forming the outlets increases in the flow direction. Because of that the pressure drop in the air and/or oxygen supplied in the gas supply member can be taken into account.

In a further embodiment it is possible that the individual outlets increase in cross section along the flow path. A comparatively more uniform volume flow of air and/or oxygen along the entire flow path can be achieved in the reaction process by this feature. This can also occurs by increasing the number or density of outlets in the gas supply member in a direction along the flow path.

In a preferred embodiment the gas supply member opens into the flow path, in which the catalyst material is found. This can be realized when the gas supply member comprises a separating wall with openings. The wall separates its interior from the flow path of the fuel and/or reformate. Because of that it is possible to obtain an optimal air and/or oxygen distribution over the catalyst surface for the reforming process. Thus a more uniform reaction process is possible along the flow path, which causes a considerably improvement of the hydrogen yield and a considerably reduction of the carbon monoxide content in the reformate gas.

According to a preferred embodiment the gas supply member is provided within the flow path. Because of that air and/or oxygen can be supplied uniformly along the flow path by a pipe-like device.

In an alternative embodiment, for example, the gas supply member is formed outside of the flow path. Also it is then possible to supply air and oxygen along the flow path simultaneously to the reforming process. For example a pipe-like device could be provided, which feeds air and/or oxygen from the exterior to the fuel stream in the reforming process.

In an embodiment which is somewhat different from the two foregoing embodiments the gas supply member and the flow path are arranged next to each other, so that air and/or oxygen can be fed to the process in an advantageous way along the flow path in an appropriately metered manner.

In an additional embodiment metering controllable components can be provided in or at the outlets or at the inlet of the gas supply member for metering the air or the oxygen. The control of these metering components can, for example, occur electrically. However it is also conceivable that the control takes place by means of a mechanical valve or hydraulic control means.

In another embodiment it is e.g. conceivable that the metering components are magnetic valves. For example these valves could have a structure comprising a perforated diaphragm, in which a needle controls the effective cross-section of the passage. The needle could be moved axially by a magnetic field, if necessary under the additional influence of a spring force and/or centrifugal force of the metered medium.

Thus it is conceivable that the metering components are arranged either in the interior of the gas supply member or also outside on it or another component, on which they act on the outlets. The metering of the respective metered amounts can also occur at the inlet of the gas supply member, when each individual outlet has its own respective connection means, e.g. a duct or passage, from the inlet to the corresponding outlet of the gas supply member.

The gas supply member can be formed in one piece or also as a plurality of elements. In the case of a one piece embodiment it can be formed as a cylindrical element with accordingly arranged passages. In the case of a plurality of elements the gas supply member can for example be a plurality of individual pipes or tubes, whose outlets correspond to the correct positions of the outlets of the one-piece member. These embodiments are exemplary and additional embodiments with similar appropriate action are conceivable within the scope of the claimed invention.

In a further developed embodiment in contrast to the embodiments above the gas supply member can be closed at one end with a closure means. Because of that a suitable gas flow resistance element can be built in at the end of the gas supply member, so that additional improvements in the distribution of air and/or oxygen are possible for supply in the flow path.

In a special embodiment the reformer is suitable for processing hydrocarbon materials with straight or branched chains of 1 to 20 carbon atoms, preferably 1 to 10 carbon atoms, as a fuel. In an additional preferred embodiment the reformer is suitable for processing of hydrocarbons with 1 to 20 carbon atoms, preferably from 1 to 10 carbon atoms, from the following classes: paraffins, olefins, naphthenes and aromates (PONA).

In an additional embodiment the reformer is suitable for processing fuels, which are composed of various hydrocarbon materials. These various hydrocarbon materials include methane, ethane, propane, butane, pentane, hexane, heptane, octane and isomers, natural gas, naphtha, liquefied refinery gas (liquefied petroleum gas—LPG), isomerates, platformate and other refinery intermediate products, preferably research octane numbers (RON=80 to 100).

In a following embodiment it is provided that the reformer is suitable for process gas containing oxygen in the form of air or oxygen enriched air with a oxygen content greater than 20 vol % and less than 80 vol % or pure oxygen.

In another embodiment the reformer should be suitable for processing a mixture of steam and hydrocarbon materials with a ratio of steam to hydrocarbons between 1.0 and 10.0, preferably between 1.0 and 4.0.

In another additional embodiment the reformer is suitable for processing a mixture with a ratio of oxygen in the reactants to total oxygen required for total oxidation of the hydrocarbons between 0.1 and 0.5, preferably between 0.1 and 0.3.

In various embodiments the reformer is designed for operation at temperatures between 300° C. and 700° C., preferably between 450° C. and 600° C.

In various embodiments the reformer is suitable for operation at pressures between 1 and 20 bar, preferably between 1.5 and 10 bar.

In various embodiments the reformer is suitable for operation with a volume flow rate between 20,000 and 200,000 I/hour.

The invention also includes a method of operating the fuel reformer for catalytic manufacture of hydrogen, especially for operation of a fuel cell, in which a hydrogen-containing reformate is produced from a fuel or from a hydrocarbon mixture supplied to the reformer by a partial oxidation (POX) and/or autothermal reforming process, wherein the fuel reformer is provided with a catalyst for at least one catalytic reaction and a gas supply member provided with a plurality of gas supply outlets for supplying the reactants into a stream of fuel and/or reformate flowing along a flow path in the reformer.

The method thus complements the fuel reformer so that the advantages called for by the individual embodiments of the fuel reformer are also the same for the method according to the invention.

The essential features of the invention include a uniform temperature distribution over the entire process of hydrogen reforming by repeatedly feeding metered amounts of the reactants, e.g. air and/or oxygen, into the flow path of the fuel or the obtained reformate. Also amazingly no oxidation of hydrogen to water takes place. Furthermore there is a massive improvement of the hydrogen yield, an improved conversion of the fuel and at the same time a reduction of the carbon monoxide content in the reformate gas. None of these effects were expected, since additional supply or air or oxygen into the hydrogen-containing reformate gas at temperatures of about 600° C. was expected to cause a complete oxidation of the fuel to water according to the current experience or expectation.

The distributed supply of air or oxygen along the flow path of the fuel or the obtained reformate with a combination of both exothermic and also endothermic reforming processes results in the above-described advantages. The currently known disadvantages of both the exothermic process and the endothermic process are successfully counteracted by means of the present invention.

Especially the changes of reaction conditions existing automatically in larger reformers are dealt with clearly better by the division of a single large reaction region into a plurality of smaller reaction regions.

The desired reaction temperatures are better controlled by distribution of air along the flow path. The temperatures along the axis are more uniform, without distributed multiple local heat inputs and/or outputs from or to the exterior.

The catalyst used in the apparatus can be used in the currently known forms. That means that it could be a powder catalyst, which is arranged in a fixed bed, and also a monolithic catalyst with a metal or ceramic base body.

The supply of air and/or oxygen through openings distributed along the flow path and the associated better control of the reaction temperature during reforming of the fuel has the additional advantage that the catalyst material used has a clearly greater service life. For example this results in higher sintering temperatures for the catalyst. However the effective surface area of the catalyst is reduced whereby it can no longer be effectively used for reforming the fuel after certain degradation processes.

The control of the reaction temperature obtained by means of the air and/or oxygen openings according to the invention avoids this disadvantage so that the catalyst can be suitably operated in its operating mode and excessive reaction temperatures do not cause damage.

A porous configuration has proven to be an ideal catalyst structure, which allows as uniform as possible a distribution of air and/or oxygen along the flow path during experimentation.

A pipe-shaped apparatus for supply of air and/or oxygen distributed along the flow path, which, for example, has a feed or supply duct diameter of 2 mm along its longitudinal axis, was used in various experiment series. This pipe-shaped apparatus is closed at its end and has four transverse passages arranged radially symmetrically at each of three positions spaced from each other along the longitudinal axis.

For example the passages of the first group of four transverse passages each have a diameter of 0.15 mm. The passages of the second group each have a diameter of e.g. 0.2 mm and the passages of the third group e.g. each have a diameter of 0.25 mm. The length of the pipe-like apparatus amounts to about 350 mm.

The axial position of the last group of four transverse passages is about 80 mm from the closed end of the pipe-shaped apparatus. The position of the next group of four passages is spaced about 100 mm from the last group. The first group of four passages is arranged about 150 mm axially from that group. The pressure range for the supplied air and/or supplied oxygen was less than or equal to 10 bar. The temperature range in the reactor was between about 550° C. and 600° C.

An improvement in the yield of hydrogen of between 25 and 65% in comparison to the yield for the prior art process was attained in many different series of experiments, depending on the experimental parameters. This surprising effect is due to the distributed supply of air and/or oxygen along the flow path of the fuel and/or the obtained reformate. The large improvement of the hydrogen yield and the increase of the fuel conversion associated with it of between 11% and 24% are not expected, because the fuel and/or the resulting reformate gas is always mixed with oxygen in a completely measured manner.

To illustrate this situation the results of a series of experiments with documented experimental conditions are described at this point in the following example.

### EXAMPLE

A catalytic fixed bed reactor system for reforming a refinery gasoline mixture (Research Octane No. (RON) 95, <1 ppm sulfur) was operated with an axial, stepped or graded, reactant supply system.

In a heated laboratory reactor with 10 mm diameter, 5 g of catalyst with 0.5 mm to 1.0 mm particle size and at a pressure of 5 bar absolute was degassed in nitrogen at a temperature of 300° C. and reduced in hydrogen at 550° C. The gasoline mixture was conducted together with air and water with different throughput over the catalyst at temperatures between 550° C. and 600° C. The equation for the autothermal chemical reaction is known from Ahmed, et al (source: S. Ahmed, A. Krumpelt, Int. J. Hydrogen Energy, 26, pp. 291-301 (2001) and given in equation IV below, in which C₇H₁₂ is the equivalent formula for the entire gasoline mixture:
C₇H₁₂+10H₂O+2 O₂+8 N₂→7 CO₂+16H₂+8 N₂ (IV).

The axial temperature profile of the reactor was controlled. Product analyses were performed with a GC-TCD-FID (Gas chromatograph with a thermo-conductivity detector and flame ionization detector) in order to calculate the mass balance (C, H, O).

The experimental results are shown in the following Table I below.

TABLE I
EXPERIMENTAL RESULTS FOR OPERATION OF A
REFORMER ACCORDING TO THE INVENTION

| Exp. No. | 1 | 2 | 3 | 4 |
|---|---|---|---|---|
| Outer Air flow Rate, ml/min | 608 | 400 | 608 | 400 |
| Inner additive flow rate, | 32 | 240 | 32 | 240 |
| ml/min | (N₂) | (air) | (N₂) | (air) |
| Heating unit Temp, ° C. | 550 | 550 | 575 | 575 |
| WHSV, g/h/g cat. | 5.1 | 5.3 | 5.3 | 5.4 |
| GHSV, ml/h/ml cat. | 59.054 | 59.098 | 59.130 | 59.767 |
| Lambda O₂ | 0.8 | 0.8 | 0.8 | 0.8 |
| Lambda H₂O | 2.6 | 2.6 | 2.5 | 2.5 |
| Hot/cold spot, ° C. | 45/5 | 37/45 | 19/−14 | 19/20 |
| Conversion HC % | 40.4 | 50.0 | 43.9 | 53.8 |
| STY I H₂/h/lrv | 7.024 | 11.570 | 9.932 | 13.996 |
| % H₂(dry) | 32.0 | 42.0 | 39.0 | 45.2 |
| % CO₂(dry) | 19.9 | 19.5 | 19.9 | 19.3 |
| % CO(dry) | 0.91 | 1.6 | 1.4 | 2.1 |
| % CH₄(dry) | 0.14 | 0.24 | 0.28 | 0.27 |
| Exp. No. | 5 | 6 | 7 | 8 |
| Outer Air flow Rate, ml/min | 1320 | 570 | 608 | 400 |
| Inner additive flow rate, | 20 | 700 | 32 | 240 |
| ml/min | (N₂) | (air) | (N₂) | (air) |
| Heating unit Temp, ° C. | 575 | 575 | 600 | 600 |
| WHSV, g/h/g cat. | 10.6 | 10.8 | 5.3 | 5.3 |
| GHSV, ml/h/ml cat. | 118.270 | 118.270 | 58.444 | 58.943 |
| Lambda O₂ | 0.8 | 0.8 | 0.8 | 0.8 |
| Lambda H₂O | 2.5 | 2.5 | 2.5 | 2.5 |
| Hot/cold spot, ° C. | 21/— | 21/−34 | −4/−23 | −5/−7 |
| Conversion HC % | 48.2 | 56.1 | 52.9 | 58.6 |
| STY I H₂/h/lrv | 21.207 | 27.7709 | 13.510 | 16.832 |
| % H₂(dry) | 37.8 | 44.9 | 44.8 | 48.3 |
| % CO₂(dry) | 18.9 | 19.1 | 19.8 | 19.0 |
| % CO(dry) | 1.6 | 2.6 | 2.8 | 2.2 |
| % CH₄(dry) | 0.30 | 0.34 | 0.31 | 0.38 |

WHSV: Weight Hourly Space Velocity, mass fuel/time/mass catalyst
GHSV: Gas Hourly Space Velocity, gas volume products/time/reactor volume
Lambda: molar ratio of O₂ and H₂O in relation to equation IV
Hot/Cold spot: Maximum (minimum) temperature in reactor versus heating unit temperature
Conversion: Converted fuel/input fuel for a definite time
STY: Space time yield, hydrogen production rate in liters of H₂/hour/l.reactor volume

For the same dwell time (GHSV constant), the results (experiments Nr. 1,2) show the same clearly higher hydrogen production (STY=11570 or +65%) when added air is distributed by the inner pipe in the reactor. In all cases the hydrogen production (25-65%) and the concentration of H₂ in the dry reformate gas (8-31%) are increased. Also the temperature uniformity is improved (experiments Nr. 3, 4) because the cold spot (−14° C.) is eliminated with additional air.

Also there are a number of reactions in the chemical and petrochemical industries, in which the hot or cold spot produced leads to a deactivation and/or loss of selectivity with respect to the desired reaction product. Complete oxidation, which could occur at high local temperature (hot spot), is desirable in none of these reactions. Instead only a partial oxidation of the products is desired (E. Newson, T. B. Truong, Int. Journal of Hydrogen Energy, 28, pp. 1379-1386 (2003).

### BRIEF DESCRIPTION OF THE DRAWING

The objects, features and advantages of the invention will now be illustrated in more detail with the aid of the following description of the preferred embodiments, with reference to the accompanying figures in which:

FIG. 1 is a longitudinal cross-sectional view of a first embodiment o a reformer for production of hydrogen according to the invention;

FIG. 2 is a transverse cross-sectional view through the reformer shown in FIG. 1 taken along the section lines I-I;

FIG. 3 is a longitudinal cross-sectional view of a second embodiment of a reformer for production of hydrogen according to the invention; and

FIG. 4 is a longitudinal cross-sectional view of a third embodiment of a reformer for production of hydrogen according to the invention;

### DESCRIPTION OF THE PREFERRED EMBODIMENTS

The reformer 1 according to the invention is provided with a gas supply member 2, which is provided for supply of air and/or oxygen in the flow path 9 of the fuel and/or the obtained reformate, as shown in FIG. 1. The air 12 flows into the gas chamber 10 of the gas supply member 2 from the input side. The output side of the gas supply member 2 is closed at its downstream end 3. It is distributed via the gas supply outlets 4, 5, 6 and penetrates or permeates the catalyst 7 arranged between the gas supply member 2 and the outer pipe 8. The catalyst 7 is arranged within the flow path 9. In the flow path 9 the air and/or oxygen is mixed with the additionally supplied reactant 11. The reformate hydrogen arises together with the occurring carbon monoxide and additional reaction gases at the appropriate reaction temperatures. The reformate gas 14 leaves at the outlet end of the reformer 1.

In the illustrated example an outer pipe 8 bounds the reformer, which closes the flow path 9 radially from the exterior. Also a required cylindrical heat unit or a heat exchanger 13 can be provided around the outer pipe 8 for controlled temperature adjustment along the axis of the reformer.

The reforming process for the fuel can always be initiated anew along the flow path 9 by the air 12 and/or the oxygen distributed along the longitudinal axis of the gas supply member 2. This happens according to the invention in a controlled reaction temperature range so that a clearly improved hydrogen production with clearly reduced carbon monoxide impurities results.

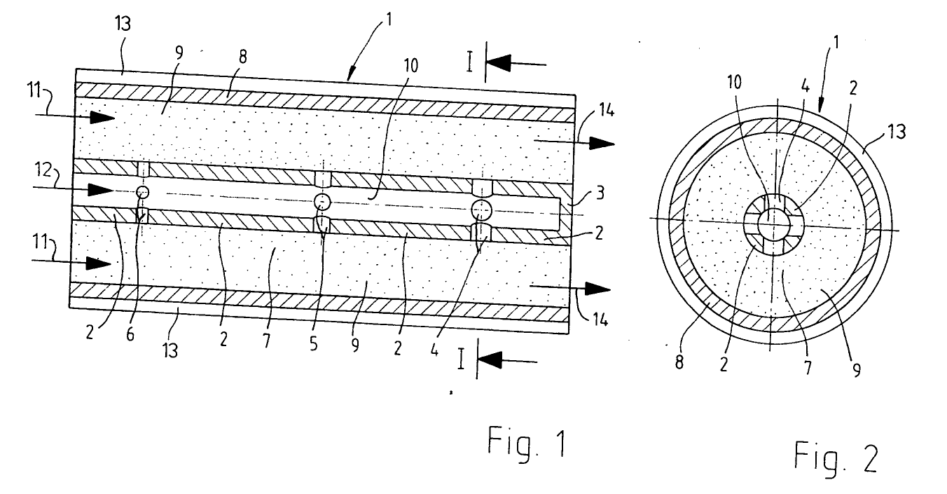

FIG. 2 shows a cross-section taken along the section lines I-I, in which the heat exchanger 13 and the outer pipe 8 radially bound the reformer 1 and close the reformer 1 from the exterior. The flow path 9 is illustrated within the outer pipe 8. A catalyst 7 is arranged within the flow path 9, in which the gas supply member 2 with the axially extending gas chamber 10 and the openings 4 opening radially are provided.

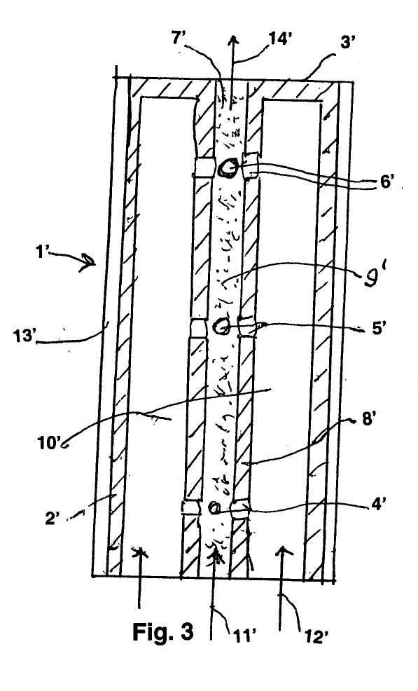

In the embodiment shown in FIG. 3, the gas supply member 2′ is arranged outside of and surrounding the flow path 9′. In this case the catalyst 7′ is arranged in an interior pipe 8′ and the fuel 11′ is supplied to the interior pipe 8′ on its inlet side. The reformate stream 14′ leaves the interior pipe 8′ from the outlet side of the fuel reformer. The gas supply member 2′ has a ring-shaped transverse cross-section and surrounds the interior pipe 8′. Gas supply outlets 4′, 5′, 6′ are provided so that air and/or oxygen 12′ can be supplied to the fuel 11′ and the catalyst 7′. The gas supply outlets 4′,5′,6′ are distributed in a non-uniform manner along the flow path 9′ becoming closer together in the flow direction. Also the cross-sectional area of the respective openings for the gas supply outlets 4′,5′,6′ increase in the flow direction along the flow path 9′. The downstream end 3′ of the gas supply member 2′ is closed as in the embodiment shown in FIG. 1. Also in this particular embodiment the interior pipe 8′ is arranged coaxially in the gas supply member 2′. A heat exchanger 13′ can also be provided here. Other parts in this embodiment as in the previous embodiment are provided with the same reference number in the drawing, except that it is a primed number.

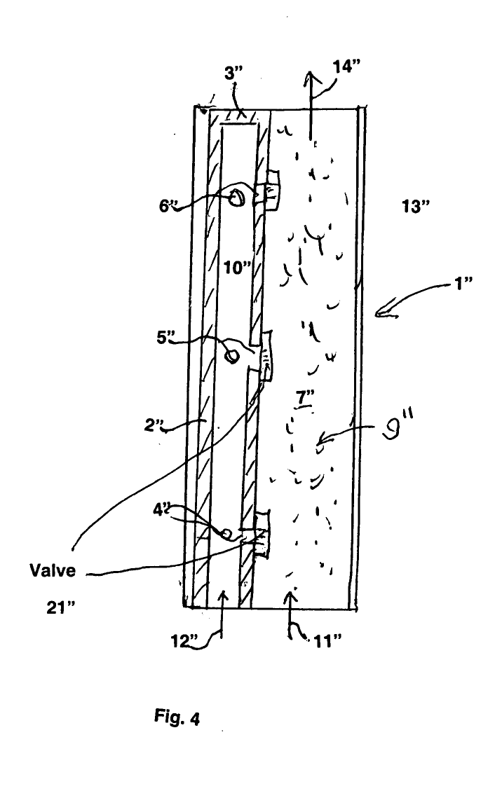

Similarly in an additional embodiment shown in FIG. 4 the flow path 9″ and the gas supply member 2″ can be arranged side-by-side or extending next to each other. Similar parts in this additional embodiment as in the previous embodiments are provided with the same reference number in the drawing, except that it is a double primed number. The gas supply member 2″ similarly has gas supply outlets 4″,5″,6″ arranged distributed non-uniformly along the flow path 9″. In this embodiment magnetic flow control valves 21″ are provided at each gas supply outlet 4″,5″, 6″ to control the supply of air and/or oxygen to fuel or hydrocarbon mixture flowing along the flow path 9″ so that non-uniformities in temperature can be better controlled. In this way the temperatures, at the hot spot can be further reduced and the temperatures in the cold spot further increased.

The particularly details of the illustrated embodiments should not be seen as limiting the invention. Other embodiments with different individual features, which fall within the scope of the invention as claimed below, are also possible.

The disclosure in German Patent Application 103 52 798.2-41 of Nov. 12, 2003 is incorporated here by reference. This German Patent Application describes the invention described hereinabove and claimed in the claims appended hereinbelow and provides the basis for a claim of priority for the instant invention under 35 U.S.C. 119.

While the invention has been illustrated and described as embodied in a fuel reformer for hydrogen production, especially for operation of a fuel cell, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features-that, from the standpoint of prior art, fairly constitute essential characteristics of the generic or specific aspects of this invention.

What is claimed is new and is set forth in the following appended claims.

1. A fuel reformer, especially for fuel cell operations, for production of a hydrogen-containing reformate from a fuel or hydrocarbon mixture supplied to the fuel reformer, by means of a partial oxidation (POX) and/or autothermal reforming process, said fuel reformer comprising a catalyst for catalysis of at least one catalytic reaction and a gas supply member for supplying reactants including air and/or oxygen, wherein said gas supply member is provided with a plurality of gas supply outlets distributed along a flow path of the fuel or the hydrocarbon mixture and/or the reformate in the reformer.

2. The fuel reformer as defined in claim 1, wherein said gas supply outlets are arranged and formed to supply said reactants transversely to the flow path.

3. The fuel reformer as defined in claim 1 or 2, wherein an open cross-section formed by said gas supply outlets increases in a flow direction along said flow path.

4. The fuel reformer as defined in claim 1 or 2, wherein respective openings of the gas supply outlets have corresponding cross-sections that increase in a flow direction along said flow path.

5. The fuel reformer as defined in claim 1 or 2, wherein said gas supply outlets increase in number in a direction along said flow path.

6. The fuel reformer as defined in claim 1 or 2, further comprising catalyst material arranged in said flow path and wherein said gas supply member opens into said catalyst material.

7. The fuel reformer as defined in claim 1 or 2, wherein said gas supply member is arranged within said flow path.

8. The fuel reformer as defined in claim 1 or 2, wherein said gas supply member is arranged outside of said flow path.

9. The fuel reformer as defined in claim 1 or 2, wherein said gas supply member and the flow path are arranged next to each other.

10. The fuel reformer as defined in claim 1 or 2, further comprising controllable metering components for said reactants arranged at said gas supply outlets or an entrance to the gas supply member.

11. The fuel reformer as defined in claim 1 or 2, wherein said gas supply member is closed at one end.

12. The fuel reformer as defined in claim 1, further comprising means for processing hydrocarbons with straight or branched chains of 1 to 20 carbon atoms.

13. The fuel reformer as defined in claim 12, wherein said straight or branched chains of said hydrocarbons have from 1 to 10 carbon atoms.

14. The fuel reformer as defined in claim 12 or 13, wherein said hydrocarbons are selected from the group consisting of paraffins, olefins, naphthenes and aromates (PONA).

15. The fuel reformer as defined in claim 1, further comprising means for reforming hydrocarbons with straight or branched chains of 1 to 20 carbon atoms.

16. The fuel reformer as defined in claim 1, further comprising means for processing said fuel and said fuel comprises at least one member selected from the group consisting of methane, ethane, propane, butane, pentane, hexane, heptane, octane, octane isomers, natural gas, naphtha, liquified refinery gas, liquified petroleum gas, isomerates and platformates.

17. The fuel reformer as defined in claim 16, wherein said fuel has a research octane number (RON) of 80 to 100.

18. The fuel reformer as defined in claim 1, further comprising means for processing air, pure oxygen or air enriched with oxygen, and wherein said air enriched with said oxygen has an oxygen content of more than 20% by volume but less than 80% by volume.

19. The fuel reformer as defined in claim 1, further comprising means for processing a mixture of hydrocarbons and steam with a ratio of said steam to said hydrocarbons of 1.0 to 10.0.

20. The fuel reformer as defined in claim 19, wherein said ratio is from 1.0 to 4.0.

21. The fuel reformer as defined in claim 1, further comprising means for processing a mixture of reactants and oxygen and wherein a ratio of said oxygen present in said mixture to an amount of said oxygen required to total oxidation of hydrocarbons in said mixture of between 0.1 and 0.5.

22. The fuel reformer as defined in claim 21, wherein said ratio is from 0.1 to 0.3.

23. The fuel reformer as defined in claim 1, further comprising means for operation to reform said fuel or said hydrocarbon mixture at temperatures between 300° C. and 700° C.

24. The fuel reformer as defined in claim 23, wherein said temperatures are between 450° C. and 600° C.

25. The fuel reformer as defined in claim 1, further comprising means for operation to reform said fuel or said hydrocarbon mixture at pressures between 1 and 20 bar.

26. The fuel reformer as defined in claim 25, wherein said pressures are between 1.5 and 10 bar.

27. The fuel reformer as defined in claim 1, further comprising means for operation to reform said fuel or said hydrocarbon mixture with a gas hourly space velocity between 20,000 and 200,000 I/hour.

28. A fuel reformer as defined in claim 1, further comprising means for operation to reform said fuel or said hydrocarbon mixture with a gas hourly space velocity between 20,000 and 200,000 I/hour at temperatures between 300° C. and 700° C. and pressures between 1 and 20 bar.

29. A fuel reformer as defined in claim 28, wherein said fuel is reformed and said fuel comprises at least one member selected from the group consisting of methane, ethane, propane, butane, pentane, hexane, heptane, octane, octane isomers, natural gas, naphtha, liquified refinery gas, liquified petroleum gas, isomerates and platformates.

30. A fuel reformer as defined in claim 28, wherein said hydrocarbon mixture is reformed, said hydrocarbon mixture comprises steam and said steam is present in said hydrocarbon mixture in a ratio of said steam to said hydrocarbons in said hydrocarbon mixture of 1.0 to 10.0.

31. A fuel reformer as defined in claim 28, wherein said hydrocarbon mixture is reformed, said hydrocarbon mixture comprises oxygen and said oxygen is present in said hydrocarbon mixture in a ratio of said oxygen to a total amount of said oxygen required for complete oxidation of said hydrocarbon mixture of from 0.1 to 0.5.

32. A process for operation of a fuel reformer for catalytic manufacture of hydrogen, especially for a fuel cell, for making a hydrogen-containing reformate from a fuel or hydrocarbon mixture supplied to the reformer by partial oxidation (POX) and/or an autothermal reforming process, said process comprising providing said fuel reformer, wherein said fuel reformer includes a catalyst for at least one catalytic reaction and a gas supply member for supplying reactants including air and/or oxygen, and wherein said gas supply member is provided with a plurality of gas supply outlets distributed along a flow path of the fuel or the hydrocarbon mixture and/or the reformate in the reformer.

33. The process as defined in claim 32, further comprising operating said fuel reformer with a gas hourly space velocity between 20,000 and 200,000 I/hour at temperatures between 300° C. and 700° C. and pressures between 1 and 20 bar.

34. The process as defined in claim 33, wherein said fuel is reformed and said fuel comprises at least one member selected from the group consisting of methane, ethane, propane, butane, pentane, hexane, heptane, octane, octane isomers, natural gas, naphtha, liquified refinery gas, liquified petroleum gas, isomerates and platformates.

35. The process as defined in claim 33, wherein said hydrocarbon mixture is reformed, said hydrocarbon mixture comprises steam and said steam is present in said hydrocarbon mixture in a ratio of said steam to hydrocarbons in said hydrocarbon mixture of 1.0 to 10.0.

36. The process as defined in claim 33, wherein said hydrocarbon mixture is reformed, said hydrocarbon mixture comprises oxygen and said oxygen is present in said hydrocarbon mixture in a ratio of said oxygen to a total amount of said oxygen required for complete oxidation of said hydrocarbon mixture of from 0.1 to 0.5.

37. The process as defined in claim 33, wherein said gas supply member is arranged within said flow path and said gas supply outlets are distributed along said flow path and formed so that temperatures of said hot spots are minimized and temperatures of said cold spots are maximized and thus reaction regions are uniformly distributed along said flow path.
